(19) United States
(12) Patent Application Publication
(10) Pub. No.: US 2003/0142401 A1
(43) Pub. Date: Jul. 31, 2003

(54) Optical member

(76) Inventors: Tominari Araki, Osaka (JP); Masanori Nakano, Osaka (JP); Kihachi Sakaida, Osaka (JP); Kouichi Kanno, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/056,973

(22) Filed: Jan. 25, 2002

(51) Int. Cl. G02B 5/30

(52) U.S. Cl. 359/488; 359/487

(57) ABSTRACT

In an optical member having a easy-releasing protective member having ink information for identification on at least one side of front and back side on optical material, wherein the optical transmittance of a portion without an ink information in the protective member is no less than 80%, and an optical transmittance of a portion with the ink information is no less than 90% of the optical transmittance of the portion without the ink information, may be easily identified various kinds of members, to give an identification information on a production line, and to make possible an appearance screening inspection with high accuracy with protective members attached on.

### BACKGROUND OF THE INVENTION

1. Field of the Invention

The present invention relates to an optical member that may undergo screening inspection of appearance with sufficient accuracy in a state where a protective member of having ink information for identification with outstanding transparency is arranged on the surface.

2. Description of the Background Art

As a method to identify an optical member for various kinds of uses, having an easy-releasing protective member comprising a protective film and a separator, etc. adhered through an adhesive layer on at least one side of front and back side of an optical material comprising polarizing plate and retardation plate etc., a method is conventionally known in which a cut is given to a corner of the member and identification is performed based on existence of the cut. However, in this corner cut method, it becomes impossible that informations required for identification of various types are given, as types of optical material increase. Moreover, when there is a necessity that a corner portion is to be used, there was problem that this corner cut method was inapplicable.

In view of the above-mentioned problem, an identification method by providing colored ink information having an easy readable property with naked eyes is tried by the present inventors. However, in optical materials, whenever they pass through predetermined processes, such as adhesion process onto liquid crystal cells, visual inspection is to be performed and there is a necessity that inferior goods that may have defects, such as soils and damages, are to be selected and removed. In this case, since in the state of having protective members on the surface inside portion is not seen through because of disturbance by a portion to which colored ink information is given, there was a problem that inspection became impossible. In optical materials, there is case where even a minute defect causes fatal defect to luminescent spot etc., and therefore an inspection with high accuracy is required.

An objects of the present invention is to provide an optical member in which various kinds of elements may be easily identified, to give an identification information on a production line to cope with a case where identification in next manufacturing process is difficult, to easily prevent soils and damages of the optical material that may cause critical defects in many cases, and to make possible an appearance screening inspection with high accuracy with protective members attached on.

### SUMMARY OF THE INVENTION

The present invention provides an optical member comprising a easy-releasing protective member having a ink information for identification on at least one side of front side and back side on the optical material, wherein an optical transmittance of a portion without the ink information in the protective member is no less than 80%, and an optical transmittance of a portion with the ink information is no less than 90% of the optical transmittance of said portion without the ink information.

The present invention in the above-mentioned optical member, the ink information comprises an ink emitting fluorescence by an irradiation of ultraviolet light.

The present invention in the above-mentioned optical, the optical material comprises at least one of a polarizing plate, a retardation plate and a brightness enhanced plate.

According to the present invention, since an identification method using an ink information is adopted, identification can cope with various kinds of optical members, and this identification information may be easily given on production line. And since the ink information given to a protective member has a form of ink information can also easily prevented soils and damages against the optical material. Moreover, a highly precise appearance screening inspection of the optical material with protective member thereon can be undergone, because a portion to which ink information is given shows a good transparency.

Especially when ink jet method is used, the above-mentioned feature that a small impact is given to the optical material when the information is provided, and therefore damage on the optical material is prevented. Furthermore, since the ink has an excellent quick-drying property and wetting property, formation of ink information is possible that has a good appearance and outstanding durability to friction. In addition, by controlling a distance between dots, fill patterns are formed in the state of few recoating of ink, and the ink information excellent in display quality is provided.

### BRIEF DESCRIPTION OF THE DRAWINGS

FIG. 1 shows a sectional drawing of an example of an optical member.

### DESCRIPTION OF THE PREFERRED EMBODIMENTS

An optical member of the present invention comprises a protective member with easy-releasing property that has an ink information for identification on at least one side of front and back side of the optical material, wherein an optical transmittance of a portion without an ink information in the protective member is no less than 80%, and an optical transmittance of a portion with the ink information shows no less than 90% of the optical transmittance of the portion without the above-mentioned ink information.

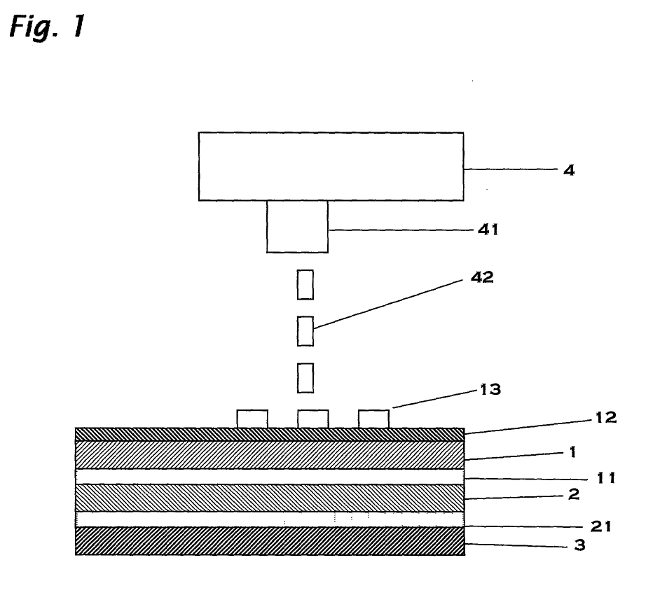

As a protective member having easy-releasing property prepared at least on one side of front side or back side of the optical material, as shown in FIG. 1, a protective film 1, a separator 3, etc. that are adhered to the optical material 2 through adhesive layers 11 and 21 may be mentioned. In addition, a reference number 13 shows an ink information given through a releasing coating 12 attached to the protective film 1. In the example of Figure, the ink information 13 is formed with transparent ink 42 through a nozzle 41 of an ink jet printer 4.

The optical material may be a suitable one used for the formation of a liquid crystal display, such as a polarizing plate, a retardation plate, an elliptically polarizing plate obtained by lamination of these, or a brightness enhanced plate, and the kind of the optical material is not particularly limited. Therefore, the polarizing plate may be a reflecting type, a semitransparent type, or the like. Further, the retardation plate may be a half wavelength plate, a quarter wavelength plate, one having a suitable object such as viewing angle compensation, or the like. In the case of an optical material of a laminate type such as the aforesaid elliptically polarizing plate, the lamination thereof may have been carried out via a suitable bonding means such as an adhesive layer.

Examples of the aforesaid polarizing plate include a polarizing film obtained by allowing a dichroic substance such as iodine or a dye to be adsorbed onto a hydrophilic polymer film such as a polyvinyl alcohol series film, partially formalized polyvinyl alcohol series film, ethylene/vinyl acetate copolymer series partially saponified film, or cellulose series film and stretching the film; or a polyene oriented film such as a dehydrated product of polyvinyl alcohol or a dehydrochlorinated product of polyvinyl chloride. The polarizing plate may have a transeparent protective layer onto one or both surface of the polarizing film

On the other hand, the reflecting type polarizing plate is for forming a liquid crystal display or the like of a type such that the incident light from the viewing side (display side) is reflected for display. This has an advantage in that the incorporation of a light source such as a backlight can be omitted to facilitate fabrication of a liquid crystal display having a reduced thickness. The reflecting type polarizing plate may be formed by a suitable method such as a method of attaching a reflecting layer made of metal or the like onto one surface of a polarizing film, optionally via a transparent protective layer or the like.

A specific example of the reflecting type polarizing plate may be one in which a foil or a vapor-deposited film made of a reflecting metal such as aluminum is attached onto one surface of a transparent protective layer made of an optionally matted film or the like. The reflecting type polarizing plate may be one having a reflecting layer of a fine undulating structure on the aforesaid diffusing type transparent protective layer. Further, the reflecting layer is preferably used in a state in which the reflecting surface thereof is covered with a transparent protective film, a polarizing plate, or the like, in view of preventing decrease in the reflectivity caused by oxidation, hence long-term duration of initial reflectivity, avoidance of separately attaching a protective layer, and other reasons.

The aforesaid reflecting layer having a fine undulating structure has advantages such as preventing directivity or glittering appearance by diffusing the incident light by random reflection, thereby restraining the unevenness of brightness. Also, the transparent protective layer containing fine particles has such an advantage that the incident light and the reflected light thereof are diffused while passing therethrough, whereby the unevenness of brightness and darkness can be further restrained.

The reflecting layer of a fine undulating structure reflecting the surface fine undulating structure of the transparent protective layer can be formed, for example, by attaching metal directly onto the surface of a transparent protective layer with the use of a suitable method of vapor deposition type such as the vacuum vapor deposition method, the ion plating method, or the sputtering method or plating type or the like.

The aforesaid conventional transparent protective layer may be made of plastics, excellent in transparency, mechanical strength, thermal stability, moisture shielding property, isotropic property, and others. The plastics include, for example, a cellulose series resin such as cellulose triacetate, polyester, polycarbonate, polyamide, polyimide, polyethersulfone, polysulfone, polystyrene, or acrylic resin, polyolefin, or thermosetting or ultraviolet-curing resin such as acryl series, urethane series, acrylurethane series, epoxy series, or silicone series, or the like.

The transparent protective layer may be formed by a suitable method such as a method of coating a polymer or a method of laminating those made into films, and the thickness thereof may be suitably determined. The thickness is typically at most 500 μm, preferably from 1 to 300 μm. more preferably from 5 to 200 μm. The fine particles to be contained in the aforesaid transparent protective film may be, for example, suitable transparent particles such as inorganic fine particles made of silica, alumina, titania, zirconia, tin oxide, indium oxide, cadmium oxide, antimony oxide, or the like having an average particle size of from 0.5 to 50 μm, which may be electrically conductive, or organic fine particles made of a cross-linked or non-cross-linked polymer or the like. The amount of fine particles to be used is typically from 2 to 50 parts by weight, preferably from 5 to 25 parts by weight, with respect to 100 parts by weight of the transparent resin.

Meanwhile, specific examples of the aforesaid retardation plate include birefringent films obtained by stretching a film made of a suitable polymer such as polycarbonate, polyvinyl alcohol, polystyrene, polymethyl methacrylate, polyolefin such as polypropylene, polyallylate, or polyamide, oriented film of liquid crystal polymer, and those in which an oriented layer of liquid crystal polymer is supported with a film.

The retardation plate may be, for example, one having a suitable retardation according to the intended usage such as compensation of various wavelength plates, coloring by birefringence of liquid crystal layer, or viewing angle, or may be a tilted orientation film with controlled refractive index in the thickness direction. Further, two or more kinds of retardation plates may be laminated to control the optical characteristics such as retardation.

The aforesaid tilted orientation film can be obtained, for example, by a method of bonding a heat-shrinking film onto a polymer film and subjecting the polymer film to a stretching process and/or a shrinking process under the action of its shrinking force by heating, a method of obliquely orienting a liquid crystal polymer, or the like method.

The optical material may be made of a laminate of two more optical layers such as a laminate of the aforesaid elliptically polarizing plate, reflecting type polarizing plate, or retardation plate. Therefore, the optical material may be a combination of polarizing plate with retardation plate and/or brightness enhanced plate, a combination of a reflecting type polarizing plate or semitransparent type polarizing plate with a retardation plate, or the like.

An optical material obtained by lamination of two or more optical layers may be formed by a method of successive and separate lamination in a process of producing a liquid crystal display or the like; however, an optical material having optical layers laminated in advance is excellent in the stability of quality and in the operability of assemblage, thereby providing an advantage of improving the efficiency in producing a liquid crystal display.

The brightness enhanced plate is sometimes referred to as polarizing separating plate, and shows such a property that, when natural light is incident, a linearly polarized light of a predetermined polarizing axis or a circular polarized light in a predetermined direction is reflected, and the other light is transmitted. The brightness enhanced plate is used for the purpose of improving brightness in a liquid crystal display.

Namely, the brightness enhanced plate is used for the purpose of improving brightness by using a method such as allowing light from a light source such as a backlight to be incident into the brightness enhanced plate so as to obtain a transmitted light in a predetermined polarized state, and allowing the reflected light to be reversed via a reflecting layer or the like to be incident into the brightness enhanced plate again, and allowing all or part thereof to be transmitted as a light in a predetermined polarized state so as to increase the amount of light transmitted through the brightness enhanced plate as well as supplying a polarized light that is hardly absorbed by a polarizing plate so as to increase the amount of light that can be used for liquid crystal display or the like.

Therefore, as the brightness enhanced plate can be used a suitable plate, for example, that shows a property of transmitting a linearly polarized light of a predetermined polarizing axis and reflecting the other light, such as a multi-layer thin film of dielectrics or a multi-layer laminate of thin films having different refractive index anisotropies (D-BEF and others manufactured by 3M Co., Ltd.), or that shows a property of reflecting one of right and left circular polarized lights and transmitting the other light, such as a cholesteric liquid crystal layer, particularly an oriented film of cholesteric liquid crystal polymer or one in which the oriented liquid crystal layer is supported on a film base material (PCF350 manufactured by NITTO DENKO CORPORATION, Transmax manufactured by Merck Co., Ltd., and others).

In the aforesaid brightness enhanced plate of a type that transmits a linearly polarized light of a predetermined polarizing axis, the light can be efficiently transmitted while restraining the absorption loss by the polarizing plate, by allowing the transmitted light to be incident, as it is, into the polarizing plate with aligned polarized axis.

On the other hand, in the brightness enhanced plate of a type that transmits a circular polarized light, such as a cholesteric liquid crystal layer, it is preferable to allow the light to be incident into the polarizing plate after converting the transmitted circular polarized light into a linearly polarized light via a retardation plate instead of allowing the light to be incident, as it is, into the polarizing plate to restrain the absorption loss. The circular polarized light can be converted into a linearly polarized light by using a quarter wavelength plate as the retardation plate and disposing the plate between the polarizing plate and the brightness enhanced plate.

A retardation plate that functions as a quarter wavelength plate in a wide wavelength range such as a visible light region can be obtained by a method such as superposing a retardation layer that functions as a quarter wavelength plate to a monochroic light such as a 550 nm wavelength light, onto a retardation layer that shows a different retardation characteristics, for example, a retardation layer that functions as a half wavelength plate. Therefore, the retardation plate to be disposed between the polarizing plate and the brightness enhanced plate may be made of one or more layers of retardation layers.

Also, as to the cholesteric liquid crystal layer, one can obtain a layer that reflects a circular polarized light in a wide wavelength range such as a visible light region by providing a configuration structure in which two or more layers are superposed using a combination of layers having different reflection wavelengths.

The optical member of the present invention comprises a easy-releasing protective member having an ink information for identification for the purpose of damage prevention etc. on one side or on both sides of front and back side of the optical material. As protective members, a protective film and a separator are generally used, as described above, and when they are used, a method is generally used in which a protective film 1 is prepared on one side of the optical material 2 as shown in Figure, and on the other hand, the adhesive layer 21 is prepared on the other side of the optical material, wherein a compound layers obtained are temporarily covered with separator 3.

In the above, protective film may be formed of a protective base alone; however, a typical protective film is formed in such a manner that an adhesive layer is disposed on a protective base so that the protective base can be released together with the adhesive layer from the optical material. On the other hand, separator is formed so that separator can be released at the interface with adhesive layer to which separator is bonded.

Therefore, generally, when the protective film is released, the surface of the optical material is exposed, whereas when the separator is released, the adhesive layer remains on the optical member, so that the adhesive layer can be used for bonding to another member such as a liquid crystal cell. The protective film can be formed so that the adhesive layer to which the protective film is bonded may remain on the optical material, in the same manner as the separator.

The adhesive substance or adhesive agent forming the adhesive layer to be disposed on the protective base or the adhesive layer to be left on the optical material, is no particular limited, can used a suitable one. An example thereof is an adhesive containing a suitable polymer such as an acryl series polymer, a silicone series polymer, polyester, polyurethane, polyamide, polyether, fluorine series polymer, or rubber series polymer, as a base polymer.

In particular, for forming an adhesive layer to be left on the optical material, it is preferable to use an adhesive being excellent in optical transparency, exhibiting adhesive characteristics of suitable wettability, cohesiveness, and adhesiveness, and being excellent in weather resistance, heat resistance, and the like, such as an acryl series adhesive. And the adhesive layer to be left on the optical material is preferably formed of an adhesive having a low moisture absorption and being excellent in heat resistance, in view of preventing a foaming phenomenon or a peeling phenomenon caused by moisture absorption, preventing decrease in the optical characteristics or warpage of the liquid crystal cell caused by thermal expansion difference or the like, hence the formability of a liquid crystal display having a high quality and being excellent in durability. The adhesive layers may comprise, suitable additives such as natural and synthetic resins; glass fibers, glass beads, fillers, pigments, coloring agents, and antioxidants, which can be blended in accordance with the needs. Further, an adhesive layer exhibiting an optical diffusion property can be made by allowing fine particles to be contained therein.

The adhesive layer can be attached onto the protective base or the optical material by a suitable method. Examples of the method include a method of preparing an adhesive solution by dissolving or dispersing an adhesive substance or a composition thereof into a solvent made of a single one or a mixture of suitable solvents such as toluene and ethyl acetate, and attaching the adhesive solution directly onto the protective base or the optical material by a suitable developing method such as the casting method or the application method, and a method of forming an adhesive layer on a separator in accordance with the above and transferring the adhesive layer onto the protective base or the optical material.

The adhesive layer can also be provided on the protective base or the optical member as superposed layers of those of different compositions, those of different kinds, or the like. The thickness of the adhesive layer can be suitably determined in accordance with the intended usage or the adhesive strength, and is typically from 1 to 500 μm, preferably from 5 to 200 μm, more preferably from 10 to 100 μm. The adhesive layers to be disposed on the protective base or the optical member may be of the same composition or kind, or of different ones.

Protective members to which the ink information for identification is given, such as protective film and separator, are manufactured using a substrate with a thin and transparent film-shape, whose optical transmittance is no less than 80%, preferably no less than 82%, and especially preferably no less than 85%, such as polymer films, rubber sheets, and laminated bodies of these materials, so that a visual inspection may be conducted with sufficient accuracy. When the ink information is not given, conventional substrates with thin film-shape of proper film, such as papers, cloths, nonwoven fabrics, nets, foamed sheets, metallic foils, and laminated bodies of those materials other than the above-mentioned substance, may be used. However, it is preferable that transparent substances as the above-mentioned substance are used in a situation where a visual inspection is required. The thickness of the protective member can be suitably determined in accordance with the strength or the like, and is typically at most 500 μm, preferably from 5 to 300 μm, more preferably from 10 to 200 μm.

The separator that is provisionally bonded to and covers the aforesaid adhesive layer is used for such purposes as preventing contamination until the adhesive layer is put to practical use or preventing unnecessary bonding that makes the handling difficult, which is caused by exposure of the adhesive layer. The separator can be formed, for example, by a method of providing a release coating layer made of a suitable release agent such as silicone series, long-chain alkyl series, fluorine series, or molybdenum sulfide on a suitable thin foliate in accordance with the needs, or the like method.

The above-mentioned releasing coating may also be prepared in surface side of the protective film 1 as shown in Figure. This releasing coating 12 is prepared so that optical members may be piled up and slipped each other to enable easy handling, when the optical members are piled up and stored transported or recovered etc. When the ink information is given to the releasing coating face, releasing coating made of long-chain alkyl derived release agents is preferable so that ink may not be repelled, and the given ink information may adhere to the face.

The polarizing film, the retardation plate, the brightness enhanced plate, the transparent protective layer, the adhesive layer or the tacky layer constituting the optical member may be allowed to have an ultraviolet absorbing capability by a method of treating with a ultraviolet absorber such as a salicylic acid ester series compound, a benzophenol series compound, a benzotriazol series compound, a cyanoacrylate series compound, or a nickel complex salt series compound.

The optical member of the present invention, the ink informations 13 for identifying types of internal optical materials etc. is given on the protective member 1 prepared on at least one side of front and back side of an optical material 2 as shown in example of Figure. And the transparent ink is used to form the ink informations so that an optical transmittance of portions that have the ink informations is no less than 90% of an optical transmittance of portions that do not have the ink informations. In addition, in example of Figure, although the ink information are given only to the protective film 1, the ink informations may be given to one or both of the protective film 1 and the separator 3 in the present invention.

Ink information given in the above-mentioned transparent ink has a purpose that inside maybe seen through in portions with the ink informations, and that as a result, appearance screening inspection of optical materials may be carried out with sufficient accuracy. Therefore a difference of the optical transmittance concerned is controlled within 10%. Since this control is performed, appearance screening inspection of existence of defect of the optical materials for the whole optical members may also be carried out using automatic check equipments based on the difference of the optical transmittance. When inspection accuracy is taken into consideration, an optical transmittance of portions with ink informations is no less than 92% of the optical transmittance of portions without them, and preferably no less than 94%, and more preferably no less than 96%.

Except for a point that the ink information for identification is formed using transparent ink satisfying a condition of the above-mentioned difference of the optical transmittance, any proper methods may be used to give the informations for identification, and there is no especially limitation about the methods. Moreover, the ink informations for identification may be arbitrarily formed using proper identification components, such as characters, figures, signs, and colors.

As the above-mentioned transparent ink, any proper materials may be used, for example, a solution in which one kind or two kinds or more of film forming components, such as transparent polymers, transparent wax, etc., are dissolved in solvent etc. Materials excellent in wettability, adhesion strength (fixability or display quality), abrasion-proof property, or durability in addition to optical transmittance are preferable. In addition, it is enough that the adhesion strength of ink may have a strength with which the ink may not be separated off by a cleaning roller and handling. Ink separation by scratching may be suppressed when ink thickness is made thinner, and an improvement in abrasion-proof property is realized especially when the thickness is no more than 5 μm.

On the other hand, a preferable formation method of ink informations for identification is a method using a printer 4 with ink jet system as shown in example of Figure. In addition, reference number 41 shows an ink jet nozzle, and 42 shows transparent ink. Ink jet method is excellent in quick-drying and wettability of ink, and ink information with good appearance and good abrasion-proof property may also be given on production line of the optical members. Further a selection of the past protective members that are given ink informations for identification beforehand may be avoided, using this method.

In the above-mentioned proper use method, if a number of types increase, selection mistake will be easily generated on experience. On the other hand, if a method generating informations on production line of the present invention is used, when optical members of many kinds are manufactured on the same line and they are treated in mixed state, ink informations for identification corresponding to the types may easily be given based on the types. Moreover, in ink jet method, since a distance between dots may be controlled easily and fill patterns etc. may be formed in the state of few recoating of ink by the distance control, and an ink information excellent in display quality is provided, and as a result a large number of identification information required for identification of various kinds of articles may also be formed easily.

Furthermore, since in the ink jet method, when ink informations are given, any materials other than transparent ink do not contact with optical members, impact given to optical materials is controlled small. A method by the present invention giving ink informations to protective members, especially a method giving ink informations to a surface outside of optical members through the protective members has outstanding advantage giving neither soils nor damages to optical materials. For this reason, especially this method is excellent in prevention effect of damages.

In addition, ink informations by transparent ink may be easily recognized also by naked eyes based on a difference of a reflection property from a portion without the ink information via reflected light. It is preferable that ink informations are formed with transparent fluorescent ink that emits fluorescence by irradiation of ultraviolet light having a wavelength of 300-415 nm, especially about 350 nm etc. in order to make reading by the naked eyes easier.

Optical members of the present invention may be easily identified for every type of materials via transparent ink informations given, and furthermore may be presented to an appearance screening inspection with protective members adhered thereon to enable manufacturing of various equipments, such as liquid crystal display, etc.

### EXAMPLES

### Example 1

A transparent protective layer that consists of triacetylcellulose film is adhered through a polyvinyl alcohol derived adhesion layer on both sides of a polyvinyl alcohol derived polarizing film to obtain a polarizing plate having a thickness of 180 μm. Then an acrylics derived adhesive layer having a thickness of 20 μm was prepared on a PET film having a thickness of 38 μm to obtain a protective film having an optical transmittance of 88%. This protective film was adhered to one side of the above-mentioned polarizing plate obtained through the adhesive layer. An acrylics derived adhesive layer having a thickness of 20 μm was prepared on a separator consisting of PET film with a thickness of 38 μm that has silicone derived releasing coating prepared on another face of the polarizing plate, and was adhered with the separator to obtain a long laminated product.

Next, the above-mentioned laminated product is punched by 15-inch size. With ink jet expression printer, using a commercial available transparent ink that emits fluorescence by an irradiation of ultraviolet light, predetermined ink informations were given on a protective film top of defective unit having a polarizing plate that is detected to have defect by prior inspection and on the defective part concerned to obtain an optical member. In addition, an optical transmittance of the protective film in a portion that was given the ink informations concerned showed 87%.

Visual inspection of the above-mentioned optical member was carried out by viewing. Portion of ink information was seen through, and a vision of the defect in internal polarizing plate could be recognized clearly, and it was able to inspect and sort defective units easily even with protective film adhered thereon. Moreover, ink informations given to the protective film emitted fluorescence by an irradiation of ultraviolet light, and were able to be easily read. Omission of ink was not observed ink information top was furthermore rubbed by hand.

What is claimed is:

1. An optical member comprising a easy-releasing protective member having a ink information for identification on at least one side of front side and back side on the optical material, wherein an optical transmittance of a portion without the ink information in the protective member is no less than 80%, and an optical transmittance of a portion with the ink information is no less than 90% of the optical transmittance of said portion without the ink information.

2. The optical member according to claim 1, wherein the ink information comprise an ink emitting fluorescence by an irradiation of ultraviolet light.

3. The optical member according to claim 1, wherein the optical material comprises at least one of a polarizing plate, retardation plate and a brightness enhanced plate.
